(19) United States
(12) Patent Application Publication
(10) Pub. No.: US 2006/0257833 A1
(43) Pub. Date: Nov. 16, 2006

(54) Motivational and behavioral modification system and method

(76) Inventors: Bernard T. Crerand, Aurora, IL (US); Sharon P. Crerand, Aurora, IL (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/407,165

(22) Filed: Apr. 19, 2006

Related U.S. Application Data
(60) Provisional application No. 60/672,703, filed on Apr. 19, 2005.

(51) Int. Cl. G09B 19/00

(52) U.S. Cl. 434/236; 434/238

(57) ABSTRACT

A motivational and behavioral modification system is provided, which comprises, in part, the use of a motivational sack with negative indicia such as an illustration of a sad or frowning face on an outer surface of the sack. The system also comprises a detailed process detailing how the motivational sack is to be used to modify a child's behavior. The system is designed to help caregivers implement a consistent method of discipline to teach a child that there are predictable consequences for their actions.

### CROSS REFERENCE TO RELATED APPLICATION

This application claims priority from U.S. Provisional Application No. 60/672,703, “BEHAVIORAL MODIFICATION SYSTEM,” filed Apr. 19, 2005, the entire contents of which is incorporated by reference as if fully set forth herein.

### FIELD OF THE INVENTION

The present invention relates to the field of child behavior modification and caregiver education and guidance, particularly in connection with the behavior of preschool-age children.

### BACKGROUND

A goal of good parenting is teaching children to behave, and doing so in a manner that is efficient, effective, and that promotes good behavioral and emotional growth for the child. At times, children behave in a manner that is inappropriate, or contrary to the caregiver's rules. It is incumbent upon a caregiver to correct such improper behavior in a manner that teaches a child a lesson, while promoting an appreciation of rules.

Presently, there does not exist a child behavioral modification or motivational system that is inexpensive, easy-to-use, and that provides simple and effective visual cues for modifying a child's behavior, and encouraging the child to make good choices. Pure reward systems, which are known in the art, do not incorporate any means for demonstrating the negative ramifications of misbehaving. Such pure reward systems generally provide a reward as an incentive for good behavior. Such systems do not provide for a disincentive for bad behavior.

### OBJECTS AND ADVANTAGES OF THE PRESENT INVENTION

Objects and advantages of the present invention include, but are not limited to: providing a motivational and behavioral modification system that will overcome the shortcomings of prior devices and systems; providing a motivational and behavioral modification system that is flexible to meet any family value system; providing a motivational and behavioral modification system that allows parents (or any caregivers) to identify positive and negative behaviors, and follow a prescribed pattern of reward and discipline; providing a turnkey motivational and behavioral modification system that is based on the following principles: establishing house rules, praising the child for good behavior, and being consistent with means of discipline; keeping a child safe, helping them learn to follow rules and make good choices, understand actions and consequences, and helping them to learn right from wrong; providing a motivational and behavioral modification system for a child that focuses on identifying positive behaviors and incorporates methods of positive reinforcement; providing a motivational and behavioral modification system where a child's “lovey” (a child's favored or preferred item, toy, blanket, object, plaything, game, article, etc.) is placed in a motivational sack (sometimes referred to herein as a “sack” or “Naughty Sak”) when a child does not follow the predetermined house rules; providing a motivational and behavioral modification system that rewards a child by returning a confiscated toy/lovey after a prescribed period of good behavior; providing a motivational and behavioral modification system for a child that includes a sack with a form of negative indicia illustrated on the outside of the sack, which can be used as a visual warning to motivate appropriate behavior; providing a motivational and behavioral modification system for a child that can be easily placed around the house, if need be, to be used as a visual cue to encourage appropriate behavior; providing a motivational and behavioral modification system for a child that is fun, simple and easy to use and understand; providing a motivational and behavioral modification system for a child that is economical to manufacture.

### DRAWING FIGURES

Similar reference characters denote corresponding features consistently throughout the attached drawings.

FIG. 1 shows a perspective view of a motivational and behavioral modification system sack according to the present invention having negative indicia thereon.

FIG. 2 shows a depiction of a caregiver observing a child break a house rule.

FIG. 3 depicts a caregiver explaining a house rule to a child.

FIG. 4 depicts a caregiver giving a child a “good boy/good girl” hug for positive reinforcement.

FIG. 5 depicts a caregiver explaining to a child what will happen if the child does not behave, and showing the child a motivational and behavioral modification system sack according to the present invention having negative indicia thereon.

FIG. 6 depicts a caregiver placing a “lovey” in the motivational and behavioral modification system sack according to the present invention having negative indicia thereon.

FIG. 7 depicts a caregiver returning a “lovey” from the motivational and behavioral modification system sack according to the present invention having negative indicia thereon to a child.

FIG. 8 is a flow chart describing an embodiment of the system of the present invention.

FIG. 9 shows a kit comprising elements of the system of the present invention, including various items of negative indicia and a brochure providing instructions for the system of the present invention.

FIG. 10 is a side view of an item of negative indicia that may removably engage the sack of the present invention.

FIG. 11a shows a side of an illustrative brochure that may accompany the sack of the present invention.

FIG. 11b shows another side of the illustrative brochure that may accompany the sack of the present invention of FIG. 11a.

### DETAILED DESCRIPTION

As used herein the term “lovey” refers to, without limitation, any favored or preferred item, toy, plaything, article, article of clothing, book, figurine, multimedia entertainment item (such as a CD or DVD), or any other similar or equivalent items or articles. A “lovey,” as used herein, includes any article or item that, if the lovey was taken away from a child or the child was deprived of the “lovey,” the child would be upset, sad, or disappointed. Examples may include, but are not limited to: a favored doll; a favored toy; a favored stuffed animal; a favored blanket; a favored DVD movie; a favored musical recording; a favored game, or other similar items.

As used herein, the term “caregiver” refers to any guardian, parent, grandparent, baby sitter, teacher, assistant, adult or older relative, nanny, or au pair, or any other monitor or caregiver charged with taking care of or otherwise monitoring the behavior of a child.

As used herein, the phrase “negative indicia” comprises any graphics, text, drawing, illustration, color or color combination, or any combinations thereof, that carry or convey a negative message to a child. Illustrative examples of such “negative indicia” are provided below.

As used herein, the term “house rule” refers to a rule set by a caregiver for a child. A house rule could pertain to, for example: no roughhousing around dangerous household objects; noisemaking; touching of objects off limits to a child; no jumping on the furniture; no hitting and/or kicking of other people; no coloring on the walls; picking up toys when finished playing with them; washing hands after dinner, using the rest room, etc.; and no getting out of bed.

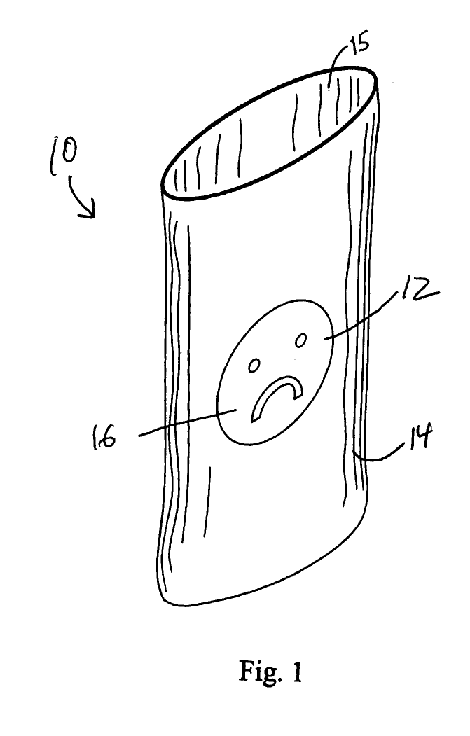

A motivational and behavioral modification system sack 10 according to the present invention (referred to herein interchangeably as the “motivational and behavioral modification system sack,” “sack” or the “Naughty Sack”) comprises a sack or bag as shown in FIG. 1. The sack 10 has an opening 15 therein. The sack 10 is preferably made of a cloth fabric, and is sized to receive such items as children's toys. The sack 10 is preferably opaque so that a child 32 cannot see through the sack 10 when a lovey 28 is placed in the sack 10, as described in greater detail below. The sack 10 could also be at least partially clear, transparent, or translucent, to enhance the “captivity” effect of a lovey 28 placed in the sack 10, whereby a child can observe the lovey 28 within the sack 10. In addition, the sack 10 is preferably formed from a breathable material that allows the passage of air as a safety feature in case a child places the sack 10 over their head.

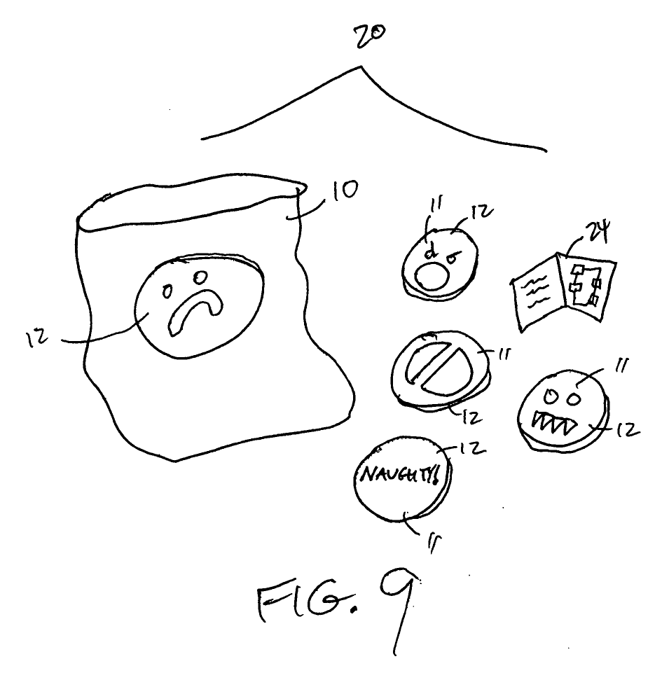

The sack 10 includes at least one item of negative indicia 12 on an outside face 14 of the sack 10. By way of illustration, the negative indicia 12 may be a depiction of a frowning face 16 as shown in FIG. 1. The negative indicia 12 could be any image, illustration, graphic, or text that conveys the message to a child 32 that the sack 10 is “bad,” or that the sack 10 is an article with negative connotations. Several examples of negative indicia 12 are shown in FIG. 9.

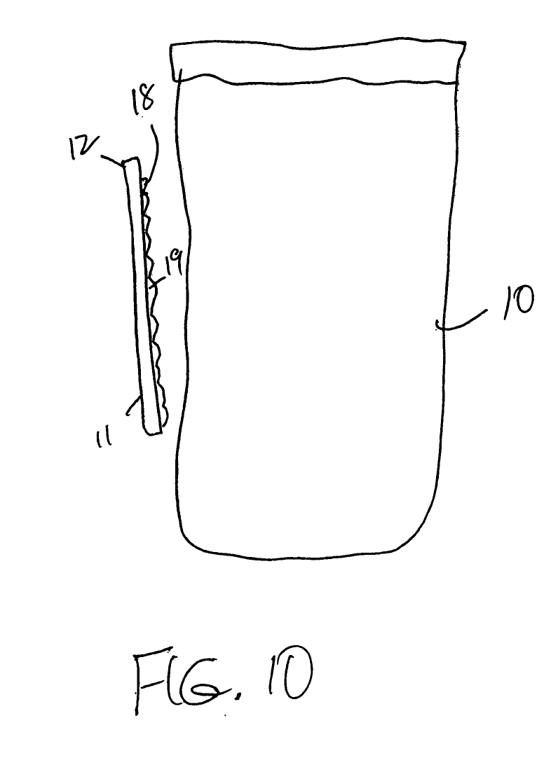

There are many negative images that may convey such a negative message to a child 32, depending on the child's 32 emotional makeup, and the sack 10 may be customizable with different images. For example, as shown in FIG. 9, the sack 10 may be formed from a material to which hook and loop-type fasteners or another type of removable engagement (snaps, buttons, adhesive, stick-tape, glue, etc.) may be used to removably attach the negative indicia 12 to a portion of the sack 10. The system of the present invention may be provided as a kit 20, as shown in FIG. 9, with various items of negative indicia 12 provided so that a caregiver can select from various choices to find the negative indicia 12 that best impacts, effects or trains a child 32. The negative indicia 12 may be provided as, for example, patches 11 or decorations, with a rear surface 18 having mating elements 19 (hook and/or loop fasteners, buttons, snaps, adhesive, tape, glue, etc.) for affixing the negative indicia 12 to the sack 10, as shown in FIG. 10. The negative indicia 12 may be provided as cloth or plastic patches in a preferred embodiment. Children of different ages may react differently to certain negative indicia 12, and a caregiver may wish to rotate or otherwise change the negative indicia 12 appearing on the sack 10 to maintain the impact of the negative indicia 12 on a child 32. Thus, the present invention provides a system that may be modified by a caregiver to the meet the caregiver's and child's needs, and that can be specifically tailored to a particular child 32. This level of flexibility adds to the usefulness of the system of the present invention.

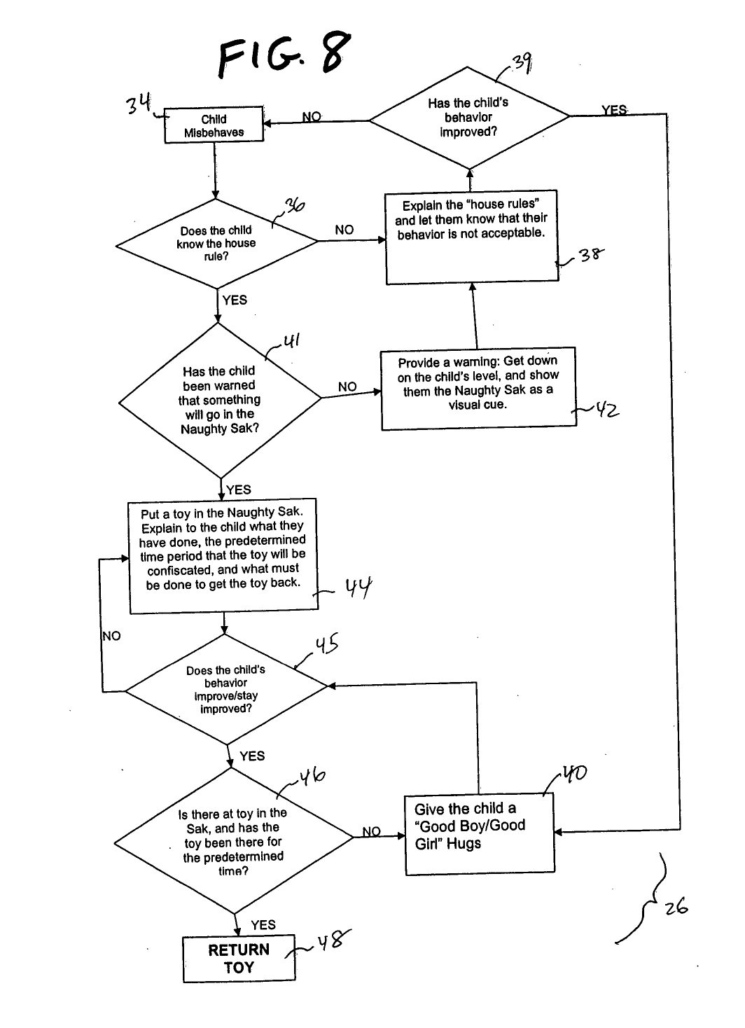

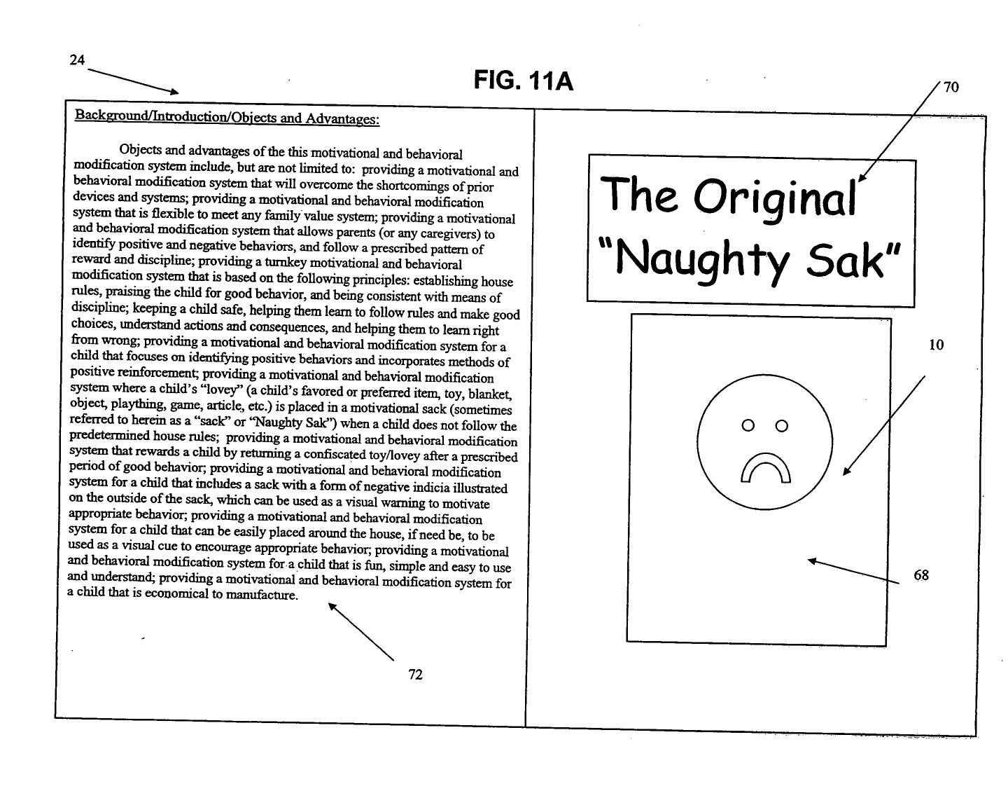

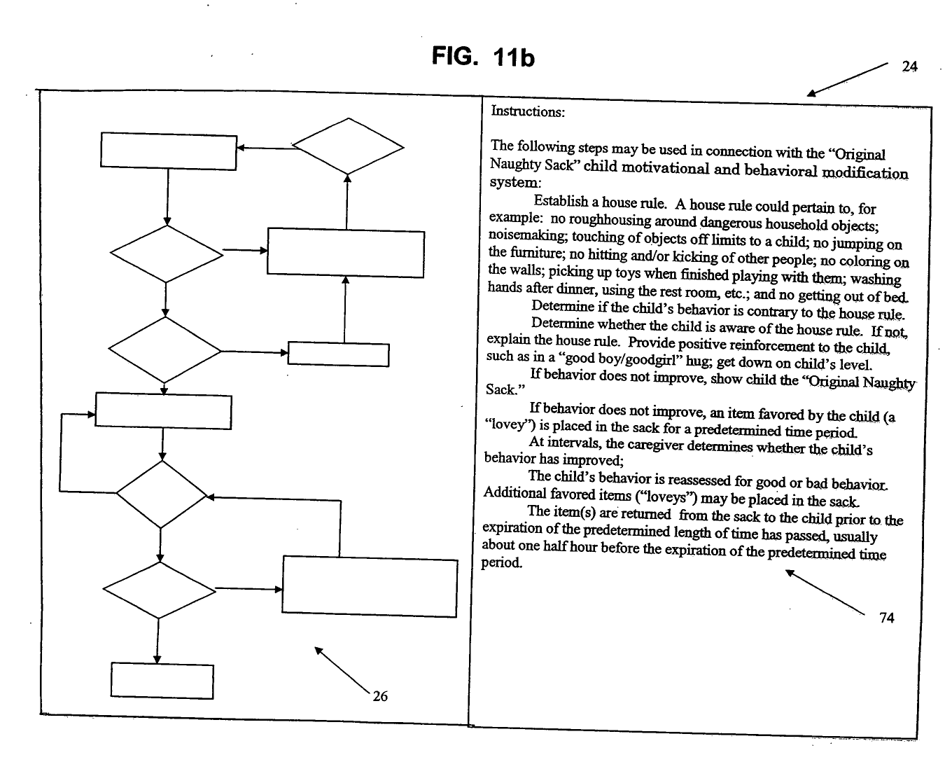

Directions for the caregiver implementing or otherwise using the motivation system of the present invention may be provided such as through an instructional or introductory brochure 24, pamphlet or instruction booklet, as shown in FIGS. 9 and 11. The brochure 24 may display an illustration 68 of the sack 10, the title 70 of the motivational and behavioral modification system, a background or introduction 72, a set of directions or instructions 74 to assist in using the behavioral modification system of the present invention, a flow chart 26 to assist in using the behavioral modification system of the present invention, or any combinations thereof. An illustrative flow chart 26 is shown in FIG. 8, and described in greater detail below. The flow chart 26 comprises directions and instructions for the system of the present invention.

### OPERATION AND USE

To use the motivational and behavioral modification system sack 10 in the context of a behavior modification system, there are multiple steps that are detailed below and represented in the flow chart 26 of FIG. 8. The system itself is a turnkey, or “ready to use” or “ready to operate,” behavioral modification system that is based on the following general principles: establishing house rules; praising a child 32 for good behavior and/or behavior consistent with the house rules; and, being consistent with means of discipline (i.e., putting a child's lovey 28 in the sack 10 if the child 32 breaks or violates a house rule and/or otherwise misbehaves). This system is designed to, among other things, keep the child 32 safe, help the child 32 learn to follow rules and encourage the child to make good choices, and help the child 32 learn right from wrong. The system provides a consistent and predictable means of discipline, but focuses equally on praise and positive reinforcement to enforce learning. The present system is also economically affordable and simple to implement and learn. The sack 10 is an integral part of the system, as it provides an important visual stimulus or visual cue when providing a warning to the child 32 and as a vehicle for discipline when the child is misbehaving.

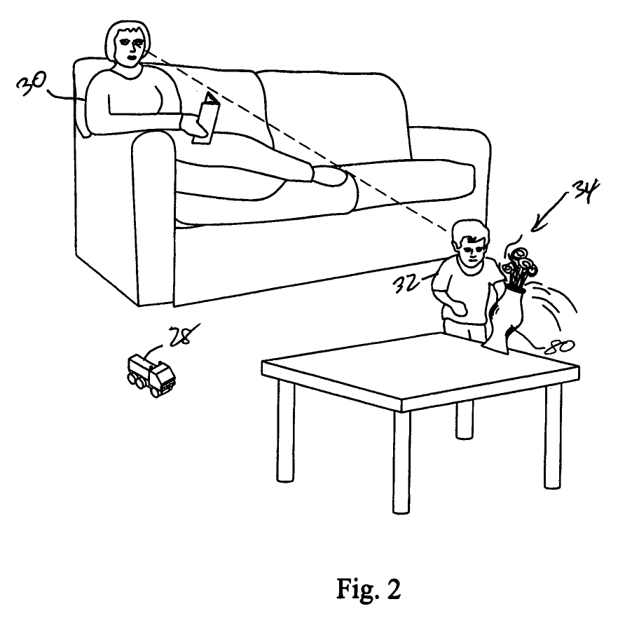

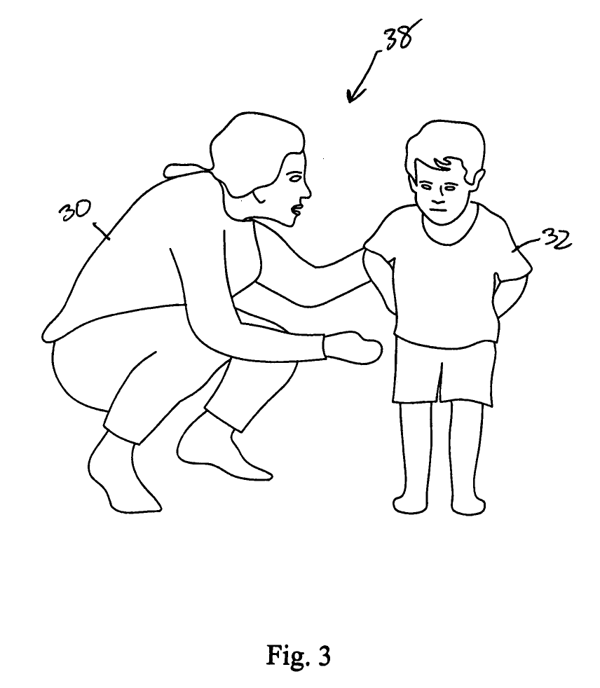

Initially, a house rule is established, and may be explained by a caregiver 30 to a child 32. For example, a house rule may be to play carefully around breakable objects, such as the vase 80 shown in FIG. 2. When a child 32 violates a house rule, such as by misbehaving 34, the caregiver 30 initially determines if the child 32 is aware of the house rule, shown in the flow chart 26 of FIG. 8 as 36. If the child is not aware of the house rule, the parent explains the house rule, and states that the behavior is unacceptable, such as depicted in FIGS. 3 and 8 as 38.

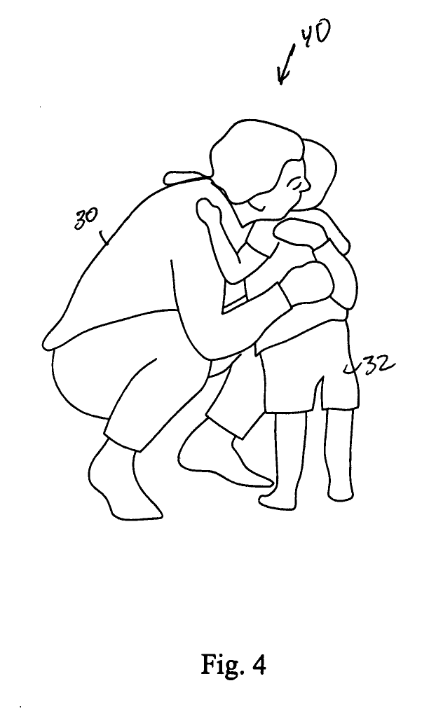

A determination is made if the child's behavior has improved, as indicated at 39 in FIG. 8. If the child's behavior improves, the caregiver 30 provides a showing of positive reinforcement, such as in the form of a “good boy/girl hug,” which is an elaborate display of affection and positive reinforcement, as depicted in FIGS. 4 and 8 as 40. The caregiver 30 physically gets down on the child 32's level, or picks the child 32 up, and gives them a big, loving hug. The caregiver 30 then explains what the child 32 has done correctly. Positive reinforcement can be displayed in other ways, such as verbally, physically, or through a present, reward or treat for the child 32.

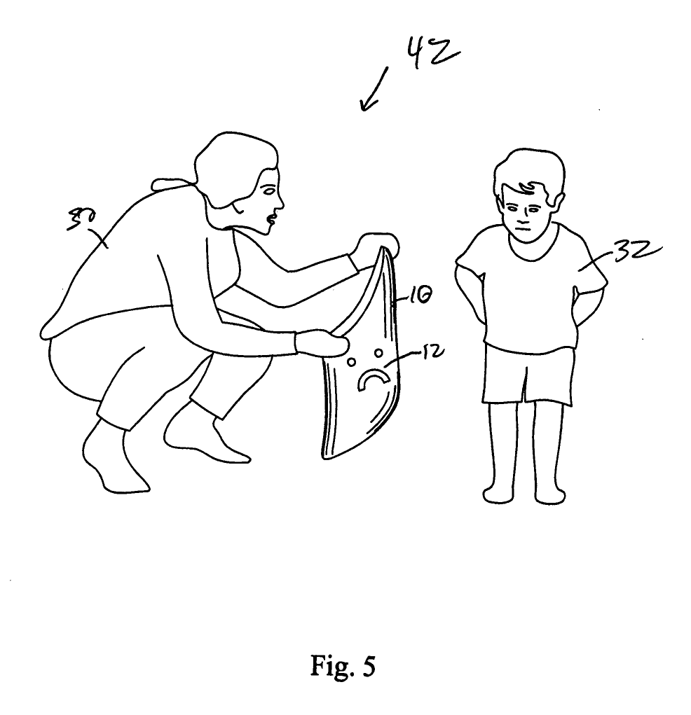

A determination is made whether the child 32 has been warned that a lovey 28 will be placed in the sack 10 if the bad behavior continues, as indicated at 41 in FIG. 8. If the child 32 did know the house rule when the child 32 violated the house rule, and was not yet warned regarding the sack 10, the caregiver 30 physically gets down to eye-level with the child 32, warns the child 32 that if they do not adjust their behavior, one of their loveys 28 will be placed in the sack 10, as depicted in FIGS. 5 and 8 as 42. The child 32 is shown the sack 10, which has the negative indicia 12 thereon, which acts as a visual warning for the child 32. The child 32 may also be reminded of the house rule, or the house rule may again be explained as in 38 of FIG. 8.

If a determination is made that the child 32 has improved their behavior at this point 39, the caregiver 30 provides positive reinforcement in the form of a “good boy/girl hug” (such as depicted in FIG. 4, and at 40 of FIG. 8), as an elaborate display of affection and positive reinforcement. The caregiver 30 physically gets down on the child's level, or picks the child 32 up, and gives them a big hug. The caregiver 30 may then explains what the child 32 has done correctly, to provide positive reinforcement.

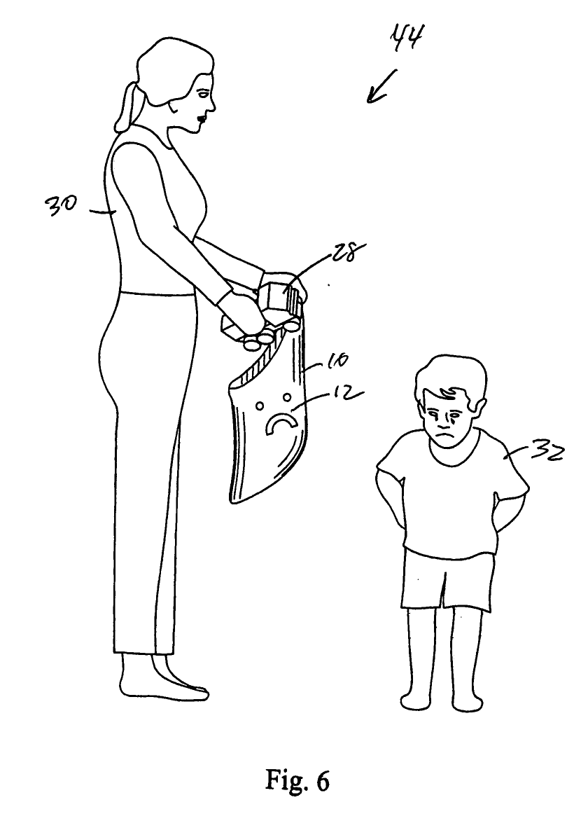

If the child 32 still does not improve their behavior, a lovey 28 is placed in the motivational and behavioral modification system sack 10, as shown in FIGS. 6 and 8 as 44, for a predetermined amount of time, designated “PTP”. The predetermined time period PTP is flexible and may be selected based on the caregiver 30's experience with the child 32. The predetermined time period PTP where the lovey 28 remains in the motivational and behavioral modification system sack 10 may be explained in the system brochure 24 to assist the caregiver 30. According to the system of the present invention, the predetermined time period PTP is selected such that a day is broken into two main periods: a first period, from when the child 32 wakes up to naptime (or lunch time if that is more convenient for the caregiver 30), and a second period from nap time/lunch time to bedtime. At selected intervals during the predetermined time period PTP, the child's behavior will be assessed, as indicated at 45 of FIG. 8, by the caregiver 30 to see if the child 32 can receive the lovey from the motivational and behavioral modification system sack 10 when the predetermined time period PTP has expired. In order for this process to be a learning experience that may modify a child's behavior, the caregiver 30 should explain to the child 32 that the child 32 has broken a house rule, and to inform the child 32 what the child 32 should have done to remain within the house rule, or what the child 32 should do properly in the future or when confronted with a similar situation.

The caregiver 30 assesses whether the child's 32 behavior has improved, as indicated at 45 of FIG. 8, during selected interval time periods ITP during the predetermined time period PTP. The interval time periods ITP may be any selected time intervals where the caregiver 30 wishes to review the child's behavior, and are flexible according to the caregiver's 30 and the child's schedule. If the child's behavior has not improved, an additional lovey 28 may be placed in the motivational and behavioral modification system sack 10 until the expiration of the predetermined time period PTP, and the child 32 is once again instructed to improve their behavior. The child 32 may alternately be reminded of the house rule at this stage as in 38 of FIG. 8, to reinforce the basis for a lovey 28 being placed in the sack 10.

If the caregiver 30 assesses that the child's behavior has improved during an interval time period ITP when the child's behavior is reviewed, the caregiver 30 determines if the lovey 28 has been in the motivational and behavioral modification system sack 10 for the predetermined time period PTP, as shown in FIG. 8 as 46. If not, the child 32 gets a “good boy/girl hug”, which is an elaborate display of affection and positive reinforcement, as depicted in FIG. 4. The caregiver 30 physically gets down on the child's level, or picks the child 32 up, and gives them a big hug. The caregiver 30 then explains what the child 32 has done correctly, and reminds the child 32 that if they keep it up, they will get their lovey(s) out of the motivational and behavioral modification system sack 10.

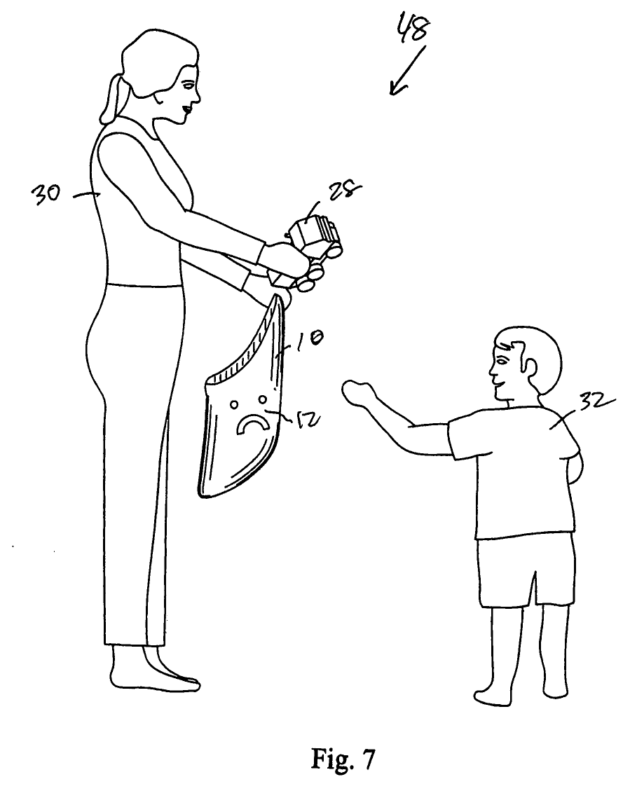

Near the expiration of the predetermined time period PTP the caregiver 30 will make a dramatic display of retrieving the lovey(s) 28 from the sack 10, depicted in FIGS. 7 and 8 as 48, and reiterating to the child 32 what they have done right, while giving them additional “good boy/girl hugs”. It is preferable that the lovey 28 is returned approximately thirty (30) minutes prior to the expiration of the predetermined time period PTP.

The caregiver 30 can refer to the brochure 24, or the system flow chart 26 at any time to make sure that they are consistently following with the program.

This system thus provides a turnkey motivational and behavioral modification system that is based on the following principles: 1) establishing house rules, 2) praising the child 32 for good behavior, and 3) being consistent with means of discipline (i.e., consistently putting a child's loveys 28 in the motivational and behavioral modification system sack if the child 32 misbehaves). This system is designed to keep the child 32 safe, help them learn to follow rules and encourage the child to make good choices, and help them learn right from wrong. It provides a consistent and predictable means of discipline, but focuses equally on praise to enforce learning. It is based on good care giving practices and is intended for use by caregivers, parents, nannies, teachers, or anyone responsible for supervising children. The motivational and behavioral modification system sack is an integral part of the system since it is used as a visual cue when providing a warning to the child 32 and as the main vehicle for discipline when they are misbehaving.

Prior to any disciplinary action, the caregiver 30 should preferably explain the “house rules”, and let the child 32 know that their behavior is not acceptable if the child 32 is misbehaving. If the child 32 continues to disobey, the child 32 will be warned, and shown the motivational and behavioral modification system sack as a visual cue. If behavior improves without the caregiver 30 having to use the motivational and behavioral modification system sack, the child 32 will receive positive reinforcement.

If the child's behavior does not improve, a toy/lovey will be placed in the motivational and behavioral modification system sack for a predetermined time period PTP. As the child's behavior improves, the caregiver 30 will continue to give positive reinforcement, and let the child 32 know that their continued adherence to the rules will extricate the child's lovey 28 from confiscation. At the predetermined time period, the loveys 28 are returned in a dramatic fashion, coupled with accolades and positive reinforcement.

It will be understood that each of the elements described above, or several together, may find a useful application in other types of methods differing from the type described above.

While certain novel features of this invention have been shown and described in the annexed claims, it is not intended to be limited to the details above, since it will be understood that various omissions, modifications, substitutions and changes in the forms and details of the present invention illustrated and in its operation can be made by those skilled in the art without departing in any way from the spirit of the present invention.

What we claim is:

1. A method of child motivational and behavioral modification, comprising:
(a) establishing a house rule;
(b) providing a sack;
(c) displaying on said sack at least one item of negative indicia;
(d) determining if a child's behavior is contrary to the house rule;
(e) placing an item favored by the child in the sack for a predetermined time period if the child's behavior is contrary to the house rule;
(f) determining whether the child's behavior has improved;
(g) determining whether the predetermined length of time has passed; and,
(h) returning the item from the sack to the child prior to the expiration of the predetermined length of time has passed.

2. The method of claim 1, and further comprising, after step (d), the step of explaining the house rule to the child.

3. The method of claim 1, and further comprising, after step (f), the step of providing the child with a display of positive reinforcement.

4. The method of claim 1, and further comprising, after step (d), the step of showing the sack including the negative indicia to the child.

5. The method of claim 4, wherein the child is warned that an item favored by the child will be placed in the sack if the child's behavior does not improve.

6. The method of claim 1, and further comprising, prior to step (c), providing an instructional brochure detailing the steps of the method.

10. The method of claim 1, wherein the negative indicia is selected from one of a plurality of negative indicia based upon an individual child's reaction to the negative indicia.

11. The method of claim 10, and further comprising the step of removably attaching the negative indicia to the sack prior to step (d).

12. The method of claim 1, and further comprising, prior to step (d), consulting a flow chart including instructions for a motivational and behavioral modification system.

13. A method of child motivational and behavioral modification, comprising:
(a) establishing a house rule;
(b) providing a sack;
(c) displaying on said sack at least one item of negative indicia;
(d) determining if a child's behavior is contrary to the house rule;
(e) determining whether a child is aware of the house rule;
(f) determining whether a child has been warned that a favored item of the child's will be placed in the sack if the child's behavior has not improved;
(g) warning the child that a preferred item will be placed in the sack if it is determined that the child was aware of the house rule;
(h) placing a favored item in the sack for a predetermined time period if the child's behavior does not improve;
(i) determining whether a child's behavior has improved; and,
(j) returning the item from the sack to the child prior to the expiration of the predetermined length of time has passed.

14. The method of claim 13, and further comprising, prior to step (d), the step of providing a flow chart detailing the steps of the method.

15. The method of claim 14, and further comprising, prior to step (d), consulting the flow chart.

15. The method of claim 13, and further comprising, prior to step (c), providing an instructional brochure detailing the steps of the method.

16. A motivational and behavioral modification system for a child, comprising:
a sack having an opening for receiving an item favored by a child, said sack having at least one item of negative indicia displayed thereon, wherein the negative indicia comprises at least one item including a removable engagement for connecting to an outer face of the sack; and,
an instructional brochure.

17. The motivational and behavioral modification system of claim 16, wherein the instructional brochure further comprises a flow chart detailing steps for a method of child motivational and behavioral modification.

18. The motivational and behavioral modification system of claim 16, further comprising a plurality of negative indicia adapted to removably engage the sack.
